(19) United States
(12) Patent Application Publication
(10) Pub. No.: US 2011/0295418 A1
(43) Pub. Date: Dec. 1, 2011

(54) SYSTEM, COMPONENTS AND METHODOLOGIES FOR PROVIDING DISRUPTIVE PROMOTIONAL MATERIAL

(76) Inventors: Christopher F. Devine, Winnetka, IL (US); Richard J. Bonick, Evanston, IL (US)

(21) Appl. No.: 13/116,918

(22) Filed: May 26, 2011

Related U.S. Application Data
(60) Provisional application No. 61/350,141, filed on Jun. 1, 2010.

(51) Int. Cl. G06F 17/00; G06Q 30/00

(52) U.S. Cl. 700/235; 705/14.5; 705/14.41; 705/14.1; 700/232

(57) ABSTRACT

Disclosed embodiments are directed, generally, to a ticket printing and issuing (e.g., vending) system and associated operations for vending such a ticket in conjunction with promotional material in the form of printed, audio and/or video advertising content, and/or electronic data. This enables distribution of promotional material in conjunction with the generation and distribution of a ticket in a manner that also distributes “disruptive promotional material” to a ticket recipient so as to provide an improved advertising effect in association with the distributed promotional material. In accordance with at least one embodiment of the invention, the ticket is a parking ticket issued in conjunction with a recipient's parking of their automotive vehicle.

### CROSS-REFERENCE TO RELATED APPLICATION(S)

This application claims the benefit of U.S. Provisional Application No. 61/350,141 filed Jun. 1, 2010, the contents of which are incorporated herein by reference.

### FIELD OF THE INVENTION

Disclosed embodiments are directed, generally, to a ticket printing and issuing (e.g., vending) system and associated operations for vending such a ticket in conjunction with promotional material in the form of printed, audio and/or video advertising content, and/or electronic data.

### DESCRIPTION OF THE RELATED ART

Conventionally, printed tickets, for example, parking tickets, in commercial parking facilities and the like have included promotional material in the form of a coupon and/or advertisement for a nearby business. Distribution of such advertisements has been considered cost effective because of the low cost associated with providing that material printed on the parking ticket.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with at least one embodiment of the invention, a system, associated component(s) and method operations are provided that enable distribution of promotional material in conjunction with the generation and distribution of a ticket in a manner that also distributes “disruptive promotional material” to a ticket recipient so as to provide an improved advertising effect in association with the distributed promotional material.

In accordance with at least one embodiment of the invention, the ticket is a parking ticket issued in conjunction with a recipient's parking of their automotive vehicle.

In accordance with at least one embodiment of the invention, the ticket includes promotional material as well as efficacy metric information enabling an advertiser to determine whether the promotional material has been effective at motivating the recipient to perform a specific task.

In accordance with at least one embodiment of the invention, the ticket is issued in conjunction with the output of audio and/or audio-video promotional material to the ticket recipient.

In accordance with at least one embodiment of the invention, the ticket is issued with promotional material that constitutes a game of chance to be played by the ticket recipient.

In accordance with at least one embodiment of the invention, the ticket and promotional material are issued in conjunction with the output of public service information.

In accordance with at least one embodiment of the invention, the ticket is issued in conjunction with an interaction with the ticket recipient's mobile device enabling the ticket vending system to contact the recipient in anticipation of an upcoming event.

In accordance with at least one embodiment of the invention, selection of promotional material output in conjunction with the issuance of a ticket is based on time of day, day of the week, data indicating particular events occurring in proximity to the ticket issuance system, etc.

### BRIEF DESCRIPTION OF THE DRAWINGS

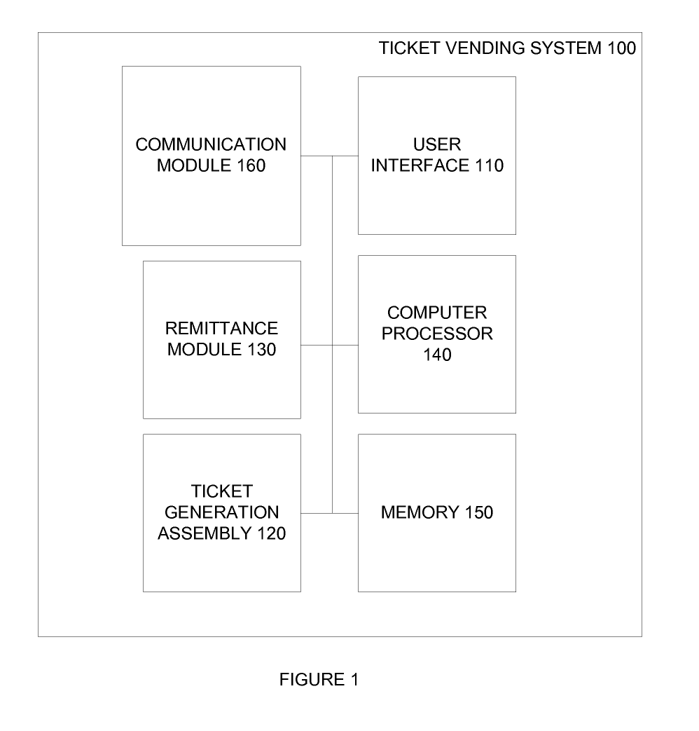

A more compete understanding of the present invention and the utility thereof may be acquired by referring to the following description in consideration of the accompanying drawings, in which like reference numbers indicate like features, and wherein FIG. 1 is a block diagram of an example of a ticket vending system designed in accordance with at least one of the disclosed embodiments.

### DETAILED DESCRIPTION

Although distribution of printed promotional material in conjunction with ticket vending systems is conventionally known, such promotional material is not disruptive to a recipient. That is, the inclusion of a coupon on the back of a parking ticket, for example, may go completely unnoticed by the ticket recipient because there is no real disruption of the ticket recipient's experience in receiving the vended ticket. This is because the promotional material is limited in its ability to attract attention of the recipient. As a result, the advertising or promotional value of the placement of that promotional material on the ticket is also limited.

To improve upon this conventionally known idea, in accordance with at least one embodiment of the invention, a system, system components and method operations are provided that alter that conventionally known ticket vending event into distribution of “disruptive promotional material.”

More specifically, the promotional material issued in conjunction with the vended ticket is not limited to print advertising but may also include audio and/or audio-visual promotional material and/or electronic data output to the ticket recipient during the ticket vending period. As a result, as illustrated in FIG. 1, a ticket vending system 100 and components provided in accordance with at least one embodiment of the invention include a user interface 110, a ticket generation assembly 120, a remittance module 130, a computer processor 140 coupled to the other components 110-130 as well as one or more computer memory devices 150 and an optional communication module 160.

By the nature of the type of promotional material and/or electronic data output to the ticket recipient during the ticket vending period, the ticket recipient's experience is altered so that the recipient is using multiple senses, e.g., hearing, vision, tactile, etc. This enables the advertiser's promotional material, e.g., commercial advertising, to be registered by the recipient in a number of different ways. As a result, those individuals with impaired hearing, will still be exposed to, for example, visual promotional content for an advertised product or services. Furthermore, the experience of a recipient with fully functional hearing and sight will benefit from the promotional material being reinforced by the multiple types of senses by which that material is being delivered.

A further benefit of utilizing multiple sensory delivery mechanisms, is that name and brand identification is further confirmed because each different sensory experience in which the advertisers' messages are delivered constitutes an additional reinforcing contact with the recipient.

The user interface 110 may include one or more display control mechanisms configured to display from stored promotional material and other additional information. As part of this display function, the user interface 110 may be configured to present a plurality of options for displaying or otherwise outputting promotional material and/or additional information to the ticket recipient during the ticket generating and vending operation. Thus, a ticket recipient may be presented with the option of receiving certain material on their vended ticket, e.g., theater show times, restaurant advertisement and/or coupons, directions to a particular location from the location of the ticket vending system 100, weather information, event information in the area, an indication of what time a vended parking ticket will expire, etc. This information may be printed in conjunction with or on the vended ticket, sent to the ticket recipient's mobile device (e.g., mobile phone, Personal Data Assistant (PDA), etc.) and/or output to the ticket recipient via a display screen and/or speaker system included in the user interface 110. The user interface 110 may include a touch-sensitive display screen and/or other type of user input device that enables the ticket recipient to select from various options including those associated with the vending of the ticket, e.g., parking duration, and output of promotional material.

The ticket generation assembly 120 may be any one of a number of conventionally known ticket generation assemblies used to generate single tickets from a set of ticket blanks, single tickets from a roll of ticket blanks, a perforated ticket-receipt pair from either a set of blanks or roll of ticket blanks etc. Accordingly assembly 120 provides the functionality to both generate a printed ticket from a blank as well as printing and vending the ticket to a ticket recipient.

The remittance module 130 is configured to accept remittance or payment in exchange for the vended ticket. As a result, the remittance module 130 may include various conventionally known components for accepting currency as coins and bills, electronic payment via voucher, debit card, credit card, etc. Additionally, the remittance module 130 may be configured to receive payment instructions via a ticket recipient's mobile device authorizing such a payment via wireless transmission.

In such situations, and others, it should be appreciated that the system 100 may be configured to send a notification to the mobile device when a ticket recipient's parking ticket duration is about to expire; such a notification may include an option to extend that duration by re-authorizing the parking ticket. As an additional option, that reauthorization may present promotional material from an advertiser offering to pay for a portion or all of that reauthorization in return for, or in connection with, the user being exposed to promotional messages from the advertiser, redeeming a coupon for the advertiser's product or service, taking a survey offered by the advertiser to gain additional information about the ticket recipient or the efficacy of the promotional material, etc.

The computer processor 140 may be, e.g., a CPU that also contains ROM, RAM, or other memory, and a storage device such as a hard disk. The computer processor 140 controls the various components of an operating system and other software stored to the internal memory for controlling operation of the other components included in the vending system.

The one or more computer memory devices 150 may likewise be ROM, RAM, or other memory and may function to store promotional information under the direction of the memory control mechanisms of the communication module 160 for output to the ticket recipient. Accordingly, the promotional material may include one or more images, text, audio files, audio-visual files, electronic coupons, etc., including any other information in addition to required print information for generating and vending the ticket for the recipient.

The communication module 160 may incorporate hardware and software that enables the system 100 to communicate with one or more sources of information, a system administrator, ticket recipient mobile devices, ticket recipient computer hardware resident at the ticket recipient's home or work, etc. The communication module 160 may be configured to communicate with such entities via one or more communication protocols and/or technologies including, wireless communication, radio, satellite, etc. The communication module 160 may include one or more memory control mechanisms for receiving and storing promotional material or other additional information, and reading the stored promotional material and other additional information as requested.

Likewise, the ticket vending system 100 may receive updates from various remote sensors indicating whether a vehicle has departed from a parking space and whether a new vehicle has replaced that parking space. By analyzing the timing associated with the parking of a vehicle and a user soliciting a ticket from the vending system 100, the ticket vending system 100 is also able to function as an intelligent parking meter system and send updates to parking attendants responsible for issuing parking citations to illegally parked vehicles. Therefore, the communication module has the ability to receive sensor updates from such parking spaces using a wireless protocol such as Bluetooth or over a Wireless Local Area Network (WLAN).

Further, it should be understood that the communication module 160 may also be configured to enable issuance of a 9-1-1 or other emergency call for emergency or rescue services to that location. As a result, the communication module 160 may include a speaker/microphone system that enables the system 100 to support a voice call to emergency services personnel.

It should be understood that, during generation and/or vending of a ticket from the vending system 100, the user interface 110 may output promotional material in one or more different forms including TV commercials, audio advertising, a game of chance to be played by the user via the interface 110, etc. Likewise, the user may select various additional information such as weather updates, local news, etc. sponsored by an advertiser and output via the user interface. Similarly, when the ticket is vended, promotional material that is associated with the output promotional material and/or additional information may be included on the ticket and/or a receipt or accompanying coupon.

The vended ticket may include a bar code or other coupon redemption data that enables an advertiser or administrator of the ticket vending system to generate data indicating whether or not a promotional offer included on the vended ticket has been utilized by the ticket recipient. Such feedback mechanisms enable the advertiser or vending system administrator to provide data indicating the effectiveness of the promotional material or offering. It should also be appreciated that the ability to include a bar code or some other unique indicia of the source of a promotional offering enables advertisers to determine and/or confirm the efficacy of the advertising and the advertising mechanism. Historically, establishing mechanisms to prove the effectiveness of advertising has always been an issue and greatly shapes advertisers' efforts at marketing their products and services. Thus, disclosed embodiments of the invention provide additional utility by providing a mechanism for confirming that an offer is being accepted by the ticket recipient through that recipient's presentation of a bar coded coupon, receipt or ticket stub to the advertiser. The invention relates in general to marketing and advertising campaigns directed to mobile device users. In particular the invention relates to methods, systems and software for determining mobile device capabilities and user abilities thereby improving management, delivery and assessment of the efficacy of marketing and advertising campaign content distribution, as specified in the independent claims.

As part of the additional information that may be presented to a ticket recipient during and/or as part of the ticket vending process, a ticket recipient may receive various public service information including, for example, AMBER alert information, weather advisory information, local event advisory information, etc.

It should also be appreciated that the promotional material output to a ticket recipient in conjunction with the ticket vending experience may be scheduled to rotate or be based on a time of day, day of week, or event data for events occurring in the immediate local area. For example, promotional material and coupons may be issued for a bagel and coffee restaurant during morning hours, whereas such material and coupons may be altered to lunch or dinner restaurant advertisers or night clubs depending on the time of day. It should be understood that various embodiments of the invention enable control of the distribution of promotional material on a targeted basis to specific ticket printing and issuing (e.g., vending) system kiosks. Such kiosks are conventionally associated with a plurality of parking spaces, e.g., on a city block, in a parking garage, etc. Thus, it should be understood that such kiosks may be conceptually thought of as localized promotional content distribution centers. Therefore, for example, a kiosk in front of a movie theater or in close proximity to a performing arts center may receive promotional material, e.g., commercial advertisements, for dinner restaurants in the area that have special seatings associated attending that theater or performing arts center. Moreover, this content can be customized as the performances change on a monthly, weekly, or daily basis to provide an enhanced experience for the ticket recipient.

The description of specific embodiments is not intended to be limiting of the present invention. To the contrary, those skilled in the art should appreciate that there are numerous variations and equivalents that may be employed without departing from the scope of the present invention. Those equivalents and variations are intended to be encompassed by the present invention.

In the above-description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in this respect.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A ticket printing and issuing system for vending a ticket to a ticket-recipient in conjunction with promotional material, the system comprising:
a user interface including at least one display control mechanism configured to output disruptive promotional material to the ticket recipient during ticket printing, issuing and/or processing of payment for the ticket;
a ticket generation assembly configured to print and vend the ticket to the ticket recipient;
a remittance module configured to accept remittance or payment in exchange for the vended ticket;
at least one computer memory device configured to store ticket-specific and disruptive promotional information; and
a computer processor coupled to the user interface, ticket generation assembly and remittance module for controlling the operation and cooperation thereof,
wherein the computer processor controls cooperation of the user interface, ticket generation assembly, remittance module and at least one computer memory device to distribute ticket-specific promotional material in conjunction with the generation and distribution of the ticket in a manner that also distributes disruptive promotional material to the ticket recipient so as to reinforce or supplement an effect of the ticket-specific promotional material.

2. The system of claim 1, wherein the ticket-specific promotional material is in the form of printed material provided on or in conjunction with the issued ticket.

3. The system of claim 1, wherein the disruptive promotional material is in the form of audio and/or video advertising content output to the ticket recipient during ticket printing, issuing and/or during processing of payment for the ticket.

4. The system of claim 1, wherein the ticket-specific promotional material is in the form of electronic data transmitted to a ticket recipient's mobile device.

5. The system of claim 1, wherein the ticket is a parking ticket that is configured to be displayed on a ticket recipient's vehicle dashboard thereby signifying permission to park in an associated vehicle parking location.

6. The system of claim 1, wherein the ticket is a parking ticket issued in conjunction with a recipient's parking of their automotive vehicle.

7. The system of claim 1, wherein the ticket includes ticket-specific promotional material as well as efficacy metric information enabling an advertiser to determine whether the promotional material has been effective at motivating the ticket recipient to perform a specific task.

8. The system of claim 1, wherein the ticket-specific promotional material is related to the disruptive promotional material output to the ticket recipient.

9. The system of claim 1, wherein ticket-specific promotional material includes material that constitutes a game of chance to be played by the ticket recipient.

10. The system of claim 1, wherein the ticket and ticket-specific promotional material are issued in conjunction with the output of disruptive promotional material that includes public service information.

11. The system of claim 10, wherein the public service information includes information about one or more events taking place near the location of the system on the day the ticket is printed and issued.

12. The system of claim 10, wherein the public service information includes information about weather near the location of the system on the day the ticket is printed and issued.

13. The system of claim 10, wherein the disruptive promotional material indicates an advertiser sponsor of the output of the public service information.

14. The system of claim 1, wherein the ticket is issued in conjunction with an interaction with the ticket recipient's mobile device enabling the ticket vending system to contact the recipient in anticipation of an upcoming event.

15. The system of claim 1, wherein the ticket-specific promotional information and/or the disruptive promotional material is selected based on time of day, day of week, and/or data indicating particular events occurring in proximity to the system.

16. The system of claim 1, wherein the ticket-specific promotional material includes theater show times, restaurant advertisement and/or coupons, directions to a particular location from the location of the system, weather information, event information in the area, and/or an indication of what time a vended parking ticket.

17. The system of claim 1, wherein the ticket generation assembly is configured to generate single tickets from a set of ticket blanks, the ticket generation assembly is configured to generate single tickets from a roll of ticket blanks, or the ticket generation assembly is configured to generate perforated ticket-receipt pairs from either a set of blanks or roll of ticket blanks.

18. The system of claim 1, wherein the ticket-specific promotional material and/or the disruptive promotional material include commercial advertising.

19. The system of claim 1, wherein the remittance module is configured to receive payment instructions via a ticket recipient's mobile device authorizing such a payment via wireless transmission.

20. The system of claim 19, further comprising a communication module configured to cooperate with the remittance module to receive payment instructions via wireless transmission.

21. The system of claim 20, wherein the communication module and remittance module are further configured to cooperate to send a notification to the mobile device when a ticket recipient's parking ticket duration is about to expire.

22. The system of claim 21, wherein the notification includes an option to extend that duration by re-authorizing the parking ticket.

23. The system of claim 22, wherein the reauthorization option includes promotional material from an advertiser offering to pay for a portion or all of that re-authorization in return for, or in connection with, the ticket recipient being exposed to promotional messages from the advertiser, redeeming a coupon for the advertiser's product or service, taking a survey offered by the advertiser to gain additional information about the ticket recipient or the efficacy of the promotional material presented to the ticket recipient.

24. A method for vending a ticket to a ticket-recipient in conjunction with promotional material, the method comprising:
outputting disruptive promotional material to the ticket-recipient via a user interface including at least one display control mechanism during ticket printing, issuing and/or processing of payment for the ticket;
printing and vending the ticket to the ticket recipient using a ticket generation assembly;
accepting remittance or payment by remittance module in exchange for the vended ticket;
storing ticket-specific and disruptive promotional information in at least one computer memory device; and
controlling, via at least one computer processor coupled to the user interface, ticket generation assembly and remittance module, distribution of ticket-specific promotional material in conjunction with the generation and distribution of the ticket in a manner that also distributes the disruptive promotional material to the ticket recipient so as to reinforce or supplement an effect of the ticket-specific promotional material.
